(19) United States
(12) Patent Application Publication
(10) Pub. No.: US 2022/0381955 A1
(43) Pub. Date: Dec. 1, 2022

(54) MOVING FRONT LENS GROUP MECHANICALLY LOCATED TO FIXED REAR LENS GROUP

(71) Applicant: ZEBRA TECHNOLOGIES CORPORATION, Lincolnshire, IL (US)

(72) Inventors: Carl D. Wittenberg, Water Mill, NY (US); Igor Vinogradov, Oakdale, NY (US); William P. Hurley, IV, New York, NY (US); David T. Shi, Setauket, NY (US)

(21) Appl. No.: 17/333,308

(22) Filed: May 28, 2021

(51) Int. Cl. G02B 3/04; G03B 17/12; G02B 1/04

(52) U.S. Cl. CPC G02B 3/04; G03B 17/12; G02B 1/041

(57) ABSTRACT

An optical assembly for an autofocus imaging system for capturing at least one image of an object appearing in an imaging field of view (FOV) is provided. The optical assembly includes a front aperture along an optical axis and a front lens group along the optical axis that receives light from the object of interest. The position of the front lens group is adjustable to change a focal distance of the optical assembly. The optical assembly further includes an actuator physically coupled to the front lens group that adjusts the position of the front lens. A rear lens group is disposed along the optical axis to receive the light from the front lens group, and an imaging sensor is disposed at a back focal distance of the rear lens group, to detect the light.

### BACKGROUND

Industrial scanners and/or barcode readers may be used in warehouse environments and/or other similar settings. These scanners may be used to scan barcodes and other objects. Such scanners are typically contained within a chassis to ensure optical components are protected from bumps, falls, and/or other potentially damaging events. In some environments, high powered scanners capable of scanning or resolving barcodes (e.g., 100 ml wide) across a wide range of distances, such as from a few inches to tens of feet, or more, may be desirable. Such systems require larger optics (e.g., imaging lens systems greater than approximately 6 mm in overall diameter) in order to meet performance requirements, but there remains a compromise between the lens system having a specific size while being constrained by the overall dimensions of the housing and the chassis. Also, compact imaging systems require high precision alignment of optics to prevent optical distortion, which can result in reduced efficiency of scanning rates, or faulty equipment. Further, larger systems may generate larger mechanical securing forces that could potentially damage the chassis or other components.

Accordingly, there is a need for improved designs having improved functionalities.

### SUMMARY

In accordance with a first aspect, an optical assembly for an autofocus imaging system is provided. The optical assembly includes a front aperture disposed along an optical axis configured to receive light from an object of interest therethrough along the optical axis. A front lens group is disposed along the optical axis configured to receive light from the object of interest. The position of the front lens group is adjustable along the optical axis and the position of the front lens group may be adjusted to change a focal distance of the optical assembly. An actuator physically coupled to the front lens group to adjust the position of the front lens group by translating the front lens group along the optical axis. A rear lens group is disposed along the optical axis to receive the light from the front lens group and further configured to provide the light to an imaging sensor. The imaging sensor is disposed along the optical axis at a back focal distance of the rear lens group, and is configured to detect the light from the rear lens group and to generate an electrical signal indicative of the light.

In a variation of this embodiment, the actuator is one of a voice coil motor, a one-dimension translation stage, a piezoelectric device, a ball-bearing linear motor, or a microelectromechanical systems (MEMS) motor. In examples the actuator has a travel distance of less than 0.5 mm. In further examples the focal distance of the optical assembly may be tuned from between 2 inches and infinity. Additionally, is some examples, the optical assembly has a back focal distance of less than 3 mm.

In some examples the optical assembly includes a front lens holder physically coupled to the front lens group to maintain a position of lenses of the front lens group, and a rear lens holder physically coupled to the rear lens group to maintain a position of lenses of the rear lens group. In these examples, the actuator may be physically coupled to the front lens holder, the actuator configured to adjust the position of the front lens by translating the front lens holder along the optical axis. In variations of the present example, the front lens holder has an outer cone and the rear lens holder has a pilot cone, wherein the outer cone is configured to abut the pilot cone to align the front lens group to the rear lens group along the optical axis. In the current variation the outer cone and pilot cone may physically align the front lens group to the rear lens group within a radial decentration error, around the optical axis, of less than 0.030 mm. In more variations, the imaging sensor is disposed on a circuit board, and the optical assembly further includes a component mounting portion that physically couples the rear lens group holder to the circuit board.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a front elevation view of an example imaging assembly of an example scanner for capturing images of an object in accordance with various embodiments;

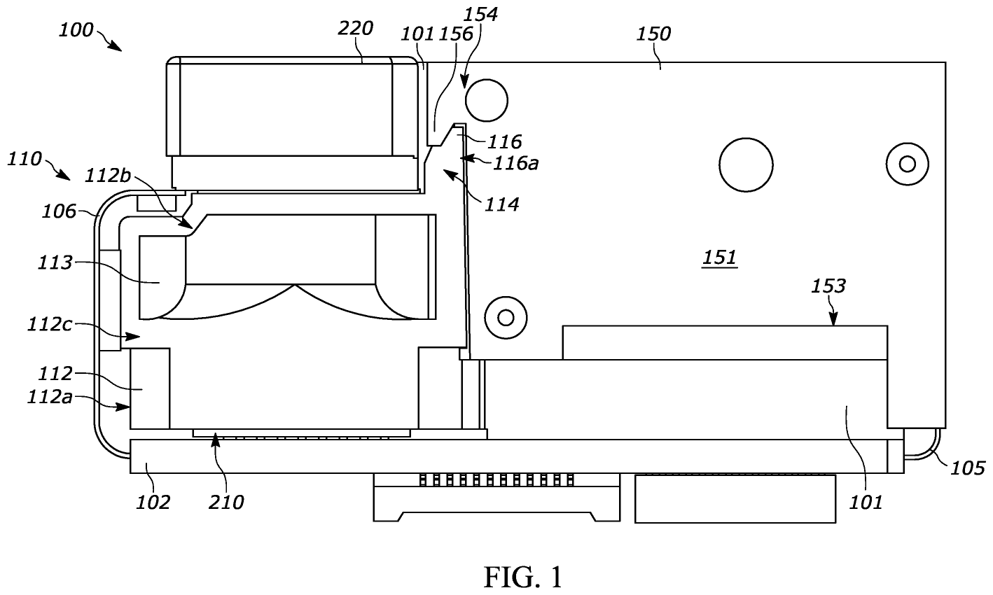

FIG. 2 illustrates a perspective view of the example imaging assembly of FIG. 1 in accordance with various embodiments;

FIG. 3 illustrates a perspective view of an example lens holder for use with the example imaging assembly of FIGS. 1 & 2 in accordance with various embodiments;

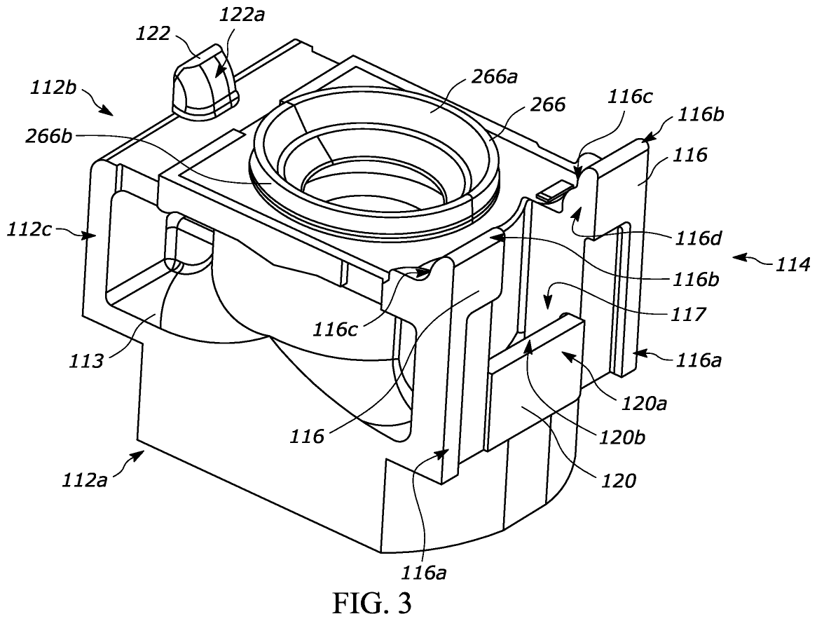

FIG. 4 illustrates a perspective view of an example chassis for use with the example imaging assembly of FIGS. 1 & 2 in accordance with various embodiments;

FIG. 5 illustrates a front elevation view of the example imaging assembly of FIGS. 1-4 during a manufacturing process in accordance with various embodiments;

FIG. 6 illustrates a first front elevation cross-sectional view of the example imaging assembly of FIGS. 1-5 in accordance with various embodiments;

FIG. 7 illustrates a second front elevation cross-sectional view of the example imaging assembly of FIGS. 1-6 in accordance with various embodiments;

FIG. 8 illustrates a perspective view of the example imaging assembly of FIGS. 1-7 in accordance with various embodiments;

FIG. 9 illustrates a top plan view of the example imaging assembly of FIGS. 1-8 in accordance with various embodiments;

FIG. 10 illustrates a front elevation cross-sectional view of the example imaging system of FIGS. 1-10 in accordance with various embodiments.

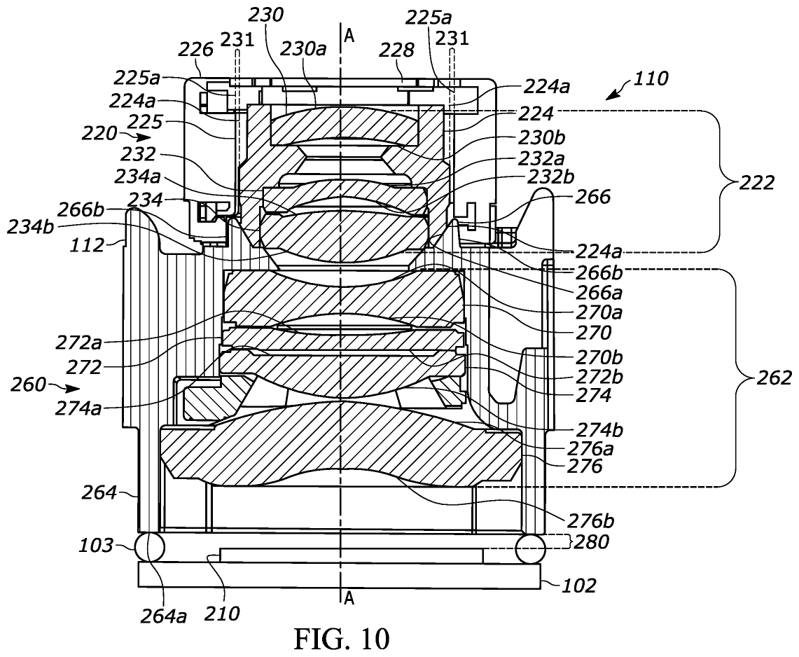

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to these various embodiments, a high-performance autofocus barcode scanner is provided having reduced dimensional requirements, and a broad range of autofocus distances. More specifically, the scanners described herein may be operably coupled with a support chassis while still utilizing all of the available height within the scanner housing. By positioning the imaging lens system adjacent to the chassis (as compared with within the chassis), the imaging lens system is not constrained by an upper height (i.e., a vertical) dimension of the chassis, and as such, can be dimensioned to occupy the entire vertical dimension. As such, the scanner may incorporate larger, higher-powered optical units capable of resolving barcodes disposed at greater distances, and greater ranges of distances, from the scanner. The scanner also incorporates optical alignment features that provide very high precision alignment of the imaging optics allowing for the use of smaller, more compact, lenses and optical elements.

Turning to the figures, an assembly 100 or scan engine for capturing at least one image of an object appearing in an imaging field of view (FOV) is provided. The assembly 100 includes a circuit board 102, an imaging system 110 operably coupled with the circuit board 102, and a chassis 150. Further, in some examples, the system 100 may include an aiming system 170 and an illumination system 180, as well as any number of additional components used to assist with capturing an image or images of an object.

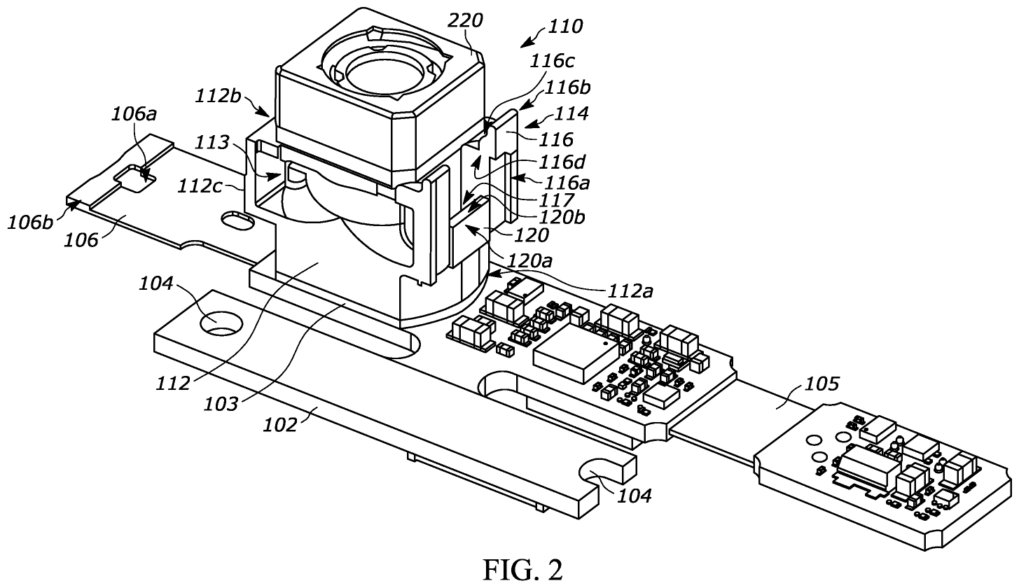

The circuit board 102 may include any number of electrical and/or electro-mechanical components (e.g., capacitors, resistors, transistors, power supplies, etc.) used to communicatively couple and/or control various electrical components of the assembly 100. For example, the circuit board 102 may include any number of component mounting portions 103, illustrated in FIG. 2, to receive components (e.g., the imaging system 110) to operably couple therewith, and may additionally include a board mounting region 104 used to secure the circuit board 102 with the scanner housing (not illustrated). In the example illustrated in FIG. 2, the circuit board 102 further includes a first flex tail connector 105 and a second flex tail connector 106. As will be discussed, the first flex tail connector 105 is used to communicatively couple components disposed within the chassis 150 with the circuit board 102, and the second flex tail connector 106 is used to communicatively couple the circuit board 102 with portions of the imaging system 110.

The imaging system 110 is also operably coupled with the circuit board 102. The imaging system 110 includes an autofocus system 220 and a rear lens holder 112, both containing lenses for imaging. The autofocus system 220 is positioned adjacent to and/or operably coupled with the rear lens holder 112. The rear lens holder 112 is in the form of a generally hollow body that defines a lower portion 112a, an upper portion 112b, and a sidewall 112c extending between the lower and upper portions 112a, 112b. The rear lens holder 112 may have any number of features such as shapes and/or cutouts 113 such that the sidewall 112c has a generally uniform thickness despite its unique shape that corresponds to the shape of the lens or lenses disposed therein. These cutouts 113 reduce overall weight of the rear lens holder 112, and due to the uniform thickness of the sidewall 112c, the rear lens holder 112 is easier to manufacture (e.g., mold via an injection molding machine) as compared with lens holders having varying thickness.

In some examples, the rear lens holder 112 is coupled with the circuit board 102 via the component mounting portion 103. As a non-limiting example, the component mounting portion 103 may be in the form of a pad to which the lower portion 112a of the rear lens holder 112 is pressed onto. The component mounting portion 103 may include an adhesive to assist in securing the rear lens holder 112 to the circuit board 102. In other examples, the component mounting portion 103 may include any number of electrical interconnects that receive corresponding electrical interconnects disposed or otherwise coupled with the rear lens holder 112. Other examples are possible.

The rear lens holder 112 further includes a lens holder mounting portion 114 positioned on an outer periphery of the sidewall 112c. The lens holder mounting portion 114 includes any number of upper tabs 116 and any number of lower tabs 120. As illustrated in FIG. 2, each of the upper tabs 116 includes a generally planar facing surface 116a, a curved upper surface 116b positioned adjacent to the facing surface 116a, an angled surface 116c positioned adjacent to the curved upper surface 116b, and an inner sidewall 116d positioned adjacent to the facing surface 116a, the curved upper surface 116b, and the angled surface 116c. In the illustrated example, the respective inner sidewalls 116d of each of the upper tabs 116 are arranged such that they face each other. The angled surface 116c is a generally planar surface that forms an angle relative to the facing surface 116a of approximately 30°. However, other examples of suitable angles are possible.

Each of the upper tabs 116 are separated by a cavity 117 at least partially defined by the inner sidewall 116d. The cavity 117 is further defined by the lower tab 120, which includes a generally planar facing surface 120a, an upper surface 120b positioned adjacent to the facing surface 120a, and an angled surface 120c positioned adjacent to the upper surface 120b. The angled surface 120c is a generally planar surface that forms an angle relative to the facing surface 120a of approximately 30°. However, other examples of suitable angles are possible. Further, while the upper surface 120b of the lower tab 120 is illustrated as a generally planar surface, in some examples, the upper surface 120b of the lower tab 120 may be curved. So configured, the cavity 117 is at least partially defined by the inner sidewalls 116d of the upper tabs 116, the sidewall 112c, and the angled surface 120c of the lower tab 120. In some examples, the width of the cavity 117 may gradually decrease from the upper portion 112b to the lower portion 112a.

The chassis 150 may be constructed from a rigid material such as a metal or metal alloy (e.g., zinc). The chassis 150 includes a body 151 that defines any number of cavities 152 in which components may be partially or fully disposed. For example, the aiming system 170 and/or the illumination system 180 may be at least partially disposed within the cavity 152 of the chassis 150. The aiming system 170 may include components to generate a cosmetic pattern to assist with identifying where the imaging system 110 is aiming. In some examples, the aiming system 170 may include laser and/or light emitting diode (“LED”) based illumination sources. The illumination system 180 assists with illuminating the desired target for the imaging system 110 to accurately capture the desired image. The illumination system 180 may include an LED or an arrangement of LEDS, lenses, and the like. For the sake of brevity, the aiming system 170 and the illumination system 180 will not be described in substantial detail.

The body 151 of the chassis 150 may include a recessed portion 153 that is adapted to receive a portion of the first flex tail connector 105 (e.g., a sub-board or an interconnect member). The chassis 150 further includes a chassis mounting portion 154 disposed or positioned on an outer periphery of the body 151 of the cavity 150. The chassis mounting portion 154 includes a reference surface 155, any number of upper hooks 156, and any number of lower hooks 160.

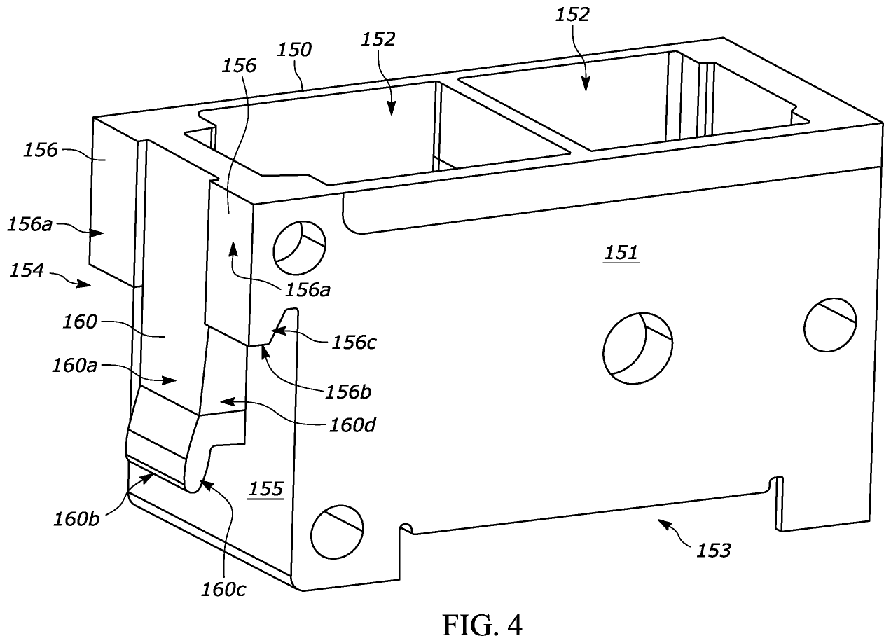

As illustrated in FIG. 4, each of the upper hooks 156 includes a generally planar facing surface 156a, a lower surface 156b (which, in some examples, may be curved) positioned adjacent to the facing surface 156a, and an angled surface 156c positioned adjacent to the lower surface 156b. The angled surface 156c is a generally planar surface that forms an angle relative to the facing surface 156a of approximately 30°. However, other examples of suitable angles are possible. Notably, and as will be discussed in further detail below, the angled surface 156c of the upper hooks 156 is configured to abut the corresponding angled surface 116c of the upper tabs 116 of the lens holder mounting portion 114. Similarly, the angle formed between the angled surface 156c and the facing surface 156a is adapted to correspond to the angle formed between the angled surface 116c and the facing surface 116a of the upper tabs 116.

As with the upper hooks 156 of the chassis mounting portion 154, the lower hook 160 of the chassis mounting portion 154 includes a generally planar facing surface 160a, a curved lower surface 160b positioned adjacent to the facing surface 160a, an angled surface 160c positioned adjacent to the lower surface 160b, and outer sidewalls 160d. The angled surface 160c is a generally planar surface that forms an angle relative to the facing surface 160a of approximately 30°. However, other examples of suitable angles are possible. Notably, and as will be discussed in further detail below, the angled surface 160c of the lower hook 160 is configured to abut the corresponding angled surface 120c of the lower tab 120 of the lens holder mounting portion 114. Similarly, the angle formed between the angled surface 160c and the facing surface 160a is adapted to correspond to the angle formed between the angled surface 120c and the facing surface 120a of the lower tab. As illustrated in FIG. 4, the lower hook 160 protrudes outwardly from the reference surface 155. Further, the lower hook 160 may have a width that corresponds to the width of the cavity 117. In examples where the cavity 117 has a reducing or tapered width, the width of the lower hook 160 may also be similarly tapered.

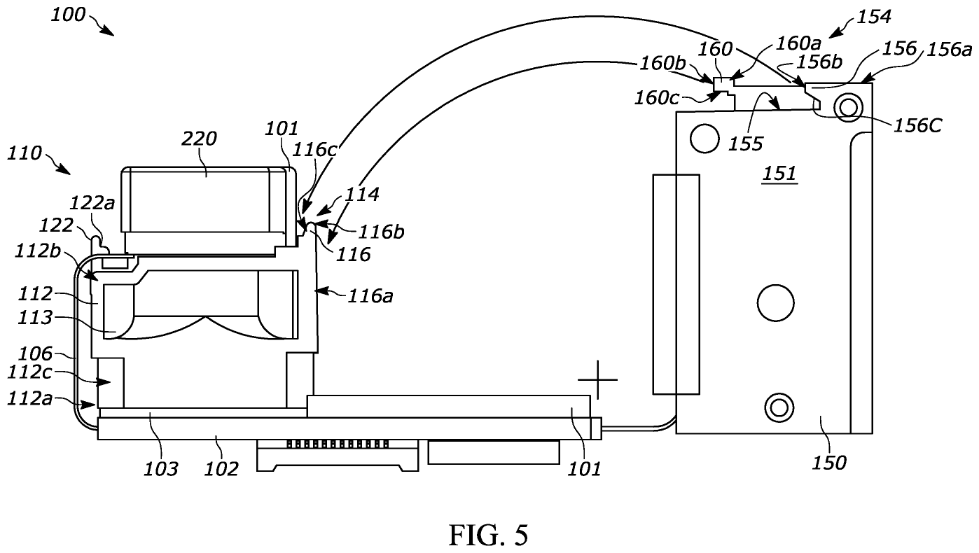

With reference to FIG. 5, the assembly 100 is assembled by first coupling the imaging system 110 (i.e., the lower portion 112a of the rear lens holder 112) with the circuit board 102 (i.e., the component mounting portion 103). Next, the first flex tail connector 105 is coupled with the components disposed within the cavity or cavities 152 by inserting the end of the first flex tail connector 105 into the recessed portion 153 of the chassis 150. Next, the chassis 150 is positioned in the illustrated raised position relative to the circuit board 102. As indicated by the arrows in FIG. 5, the chassis 150 is rotated to a lowered position whereby the chassis mounting portion 154 couples with the lens holder mounting portion 114. More specifically, the curved lower surface 160b of the lower hook 160 of the chassis 150 enters the cavity 117 formed by the lens holder mounting portion 114 and engages the corresponding upper surface 120b of the lower tab 120 of the rear lens holder 112, and the lower surface 156b of the upper hooks 156 of the chassis 150 engage the corresponding curved upper surface 116b of the upper tabs 116 of the rear lens holder 112. As such, the chassis 150 may be rotated to its final position while hinging around the flex tail connector 105 with the circuit board 102 without interference. In some examples, the widths of the cavity 117 and the lower hook 160 are dimensioned to create a close fit when coupled together.

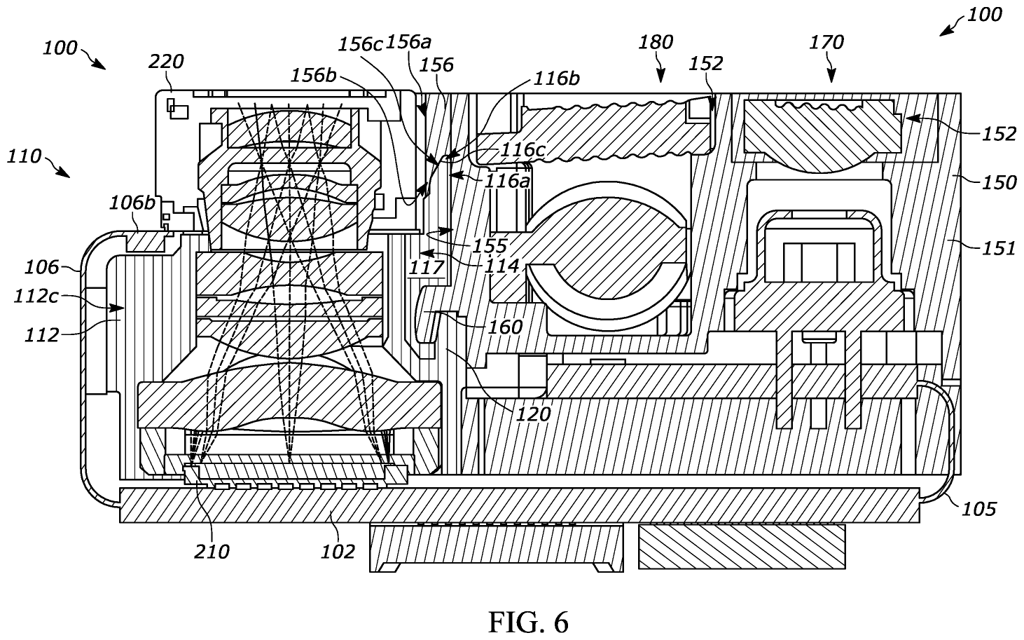

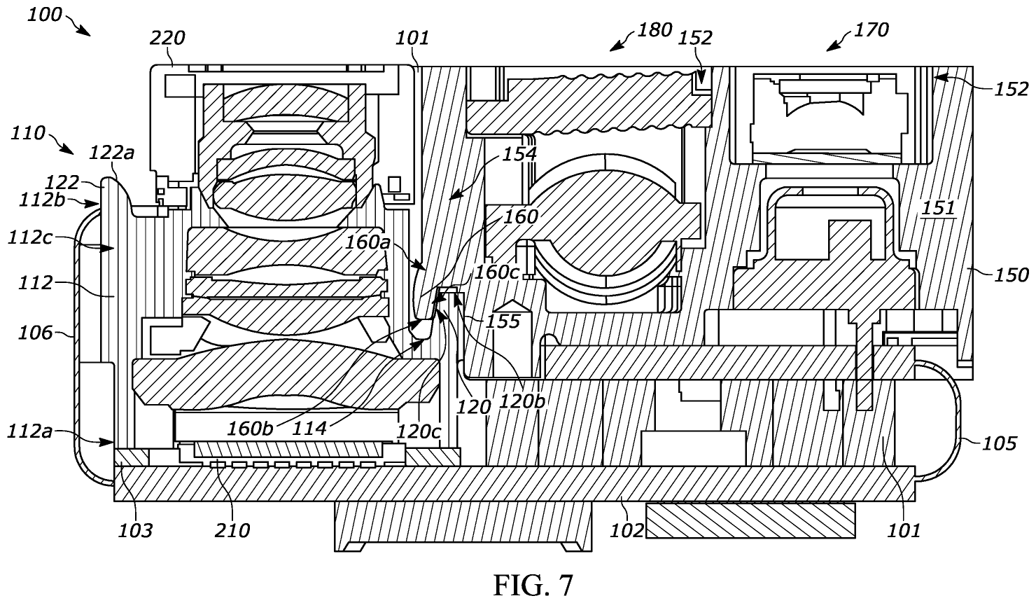

The lower tab 120 of the rear lens holder 112 and the lower hook 160 of the chassis 150 engage each other to move, urge, or squeeze the chassis 150 against the rear lens holder 112 (FIGS. 6 and 7), and the upper tabs 116 of the rear lens holder 112 and the upper hooks 156 of the chassis 150 act as wedges that slide against each other (via the angled surfaces 116c, 156c) until movement is restricted (FIG. 6).

In this arrangement, additional cavities may be formed between the lens holder mounting portion 114 and the chassis mounting portion 154. An epoxy or other adhesive 101 may be applied in these regions between the lens holder mounting portion 114 and the chassis mounting portion 154 to ensure the components may not move or separate relative to each other. In some of these examples, coupling of the lens holder mounting portion 114 and the chassis mounting portion 154 results in specified dimensional tolerances that may be filled by the epoxy or adhesive 101. Accordingly, there is a reduced requirement that the lens holder mounting portion 114 and the chassis mounting portion 154 be precisely mated with each other, thereby reducing manufacturing costs. In some examples, portions of the chassis 150 may include curved or cylindrical surfaces to assist with locating and rotating the chassis 150 into its relative lowered position. Further, in some examples, an epoxy material 101 may be added below or between the chassis 150 and the circuit board 102.

As a result of the mating coupling between the lens holder mounting portion 114 and the chassis mounting portion 150, the reference positioning surface 155 of the chassis 150 abuts the facing surface 116a of the upper tabs 116 of the chassis. By providing precise dimensions of the chassis 150 (and in turn, of the reference positioning surface 155), precise relative positioning of the imaging system 110 and the chassis 150 (in addition to the components disposed therein) is achieved. The plane-to-plane engagement of the chassis 150 and the imaging system 110 remove three degrees of freedom (i.e., left-right motion, tip, and tilt), while the engagement between the upper and lower tabs 116, 120 of the rear lens holder 110 and the upper and lower hooks 156, 160 of the chassis 150 remove an additional degree of freedom (i.e., vertical movement). The remaining degrees of freedom are eliminated by a surface of a fixture used during the curing process for the epoxy or other adhesive. After moving the chassis 150 into position, a nesting surface positioned behind the components illustrated in FIG. 5 will provide for remaining alignment, thus removing the remaining two degrees of freedom.

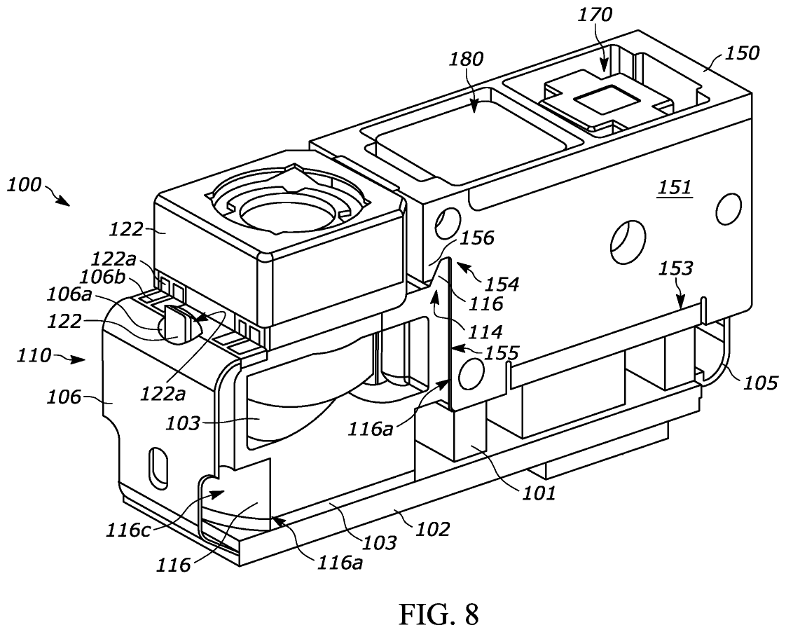

With reference to FIG. 8, the second flex tail connector 106 includes a mounting opening 106a and a number of interconnects 106b. The rear lens holder 112 includes a flex securing tab 122 that protrudes upwardly from the rear lens holder 112. The flex securing tab 122 includes an angled engaging surface 122a which is angled in a direction towards the autofocus system 220. When electrically coupling the autofocus system 220 with the circuit board, the second flex tail connector 106 is urged upward, and the mounting opening 106a is aligned with the flex securing tab 122. Because the engaging surface 122a of the flex securing tab 122 is angled towards the autofocus system 220, the interconnects 106b are moved or positioned against corresponding interconnects 220a positioned on the autofocus system 220, thereby communicatively coupling the autofocus system 220 with the circuit board 102. In some examples, the flex securing tab 122 may include a notch or other feature used to retain the second flex tail connector 106.

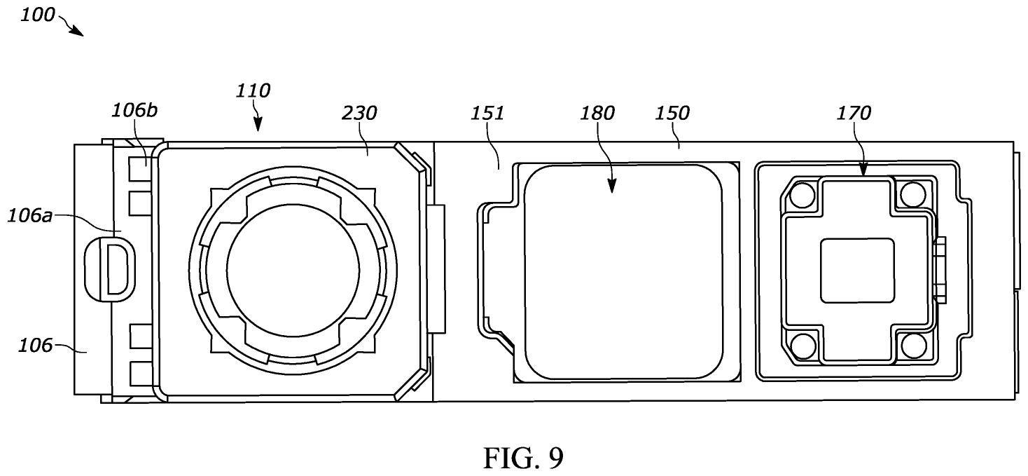

With reference to FIG. 9, the optical arrangement of the imaging system 110 will be described in greater detail. The imaging system 110 is configured to image an object of interest or a target with which may include one or more of a 1D barcode, 2D barcode, QR code, UPC code, or indicia indicative of the object of interest. The imaging system 110 includes the autofocus system 220 and the stationary optics system 260. The autofocus system 220 has a front lens group 222 and a front lens holder 224. The front lens group 222 is disposed along an optical axis A, and the front lens holder 224 is physically coupled to the front lens group 222 to control a position of the front lens group 222 along the optical axis A and to maintain relative positions of the lenses of the front lens group 222 with respect to each other. An actuator is physically coupled to the front lens group holder 224 to translate the front lens group holder 224 along the optical axis A, to change a focal distance of the imaging system 110 to image an object of interest. The autofocus system 220 may further include an outer mount 226 that houses the front lens group holder 224 and maintains a lateral position (i.e., a position along a plane orthogonal to the optical axis A) of the front lens group holder 224 and the front lens group 222. The outer mount 226 has a front aperture 228 disposed along the optical axis A to allow light from the object of interest therethrough for scanning of the object.

The stationary optics system 260 includes a rear lens group 262 and a rear lens group holder 112. The real lens group holder 112 is physically coupled to lenses of the rear lens group 262 to support and maintain a position of each lens of the rear lens group 262 along the optical axis A. The rear lens group 262 is positioned to receive light from the front lens group 222 for imaging the object of interest. The rear lens group holder 112 has a rear lens barrel flange 264 that may be physically coupled to a component mounting portion 103 to couple the rear lens holder 112 to the circuit board 102 to maintain a position of the autofocus imaging system 110 relative to the imaging sensor 210.

The front lens group holder 224 has an outer cone 224a, and the rear lens group holder has a pilot ridge 266 for aligning the position of the front lens group 222 along the optical axis A with the rear lens group 262. The pilot ridge 266 has a pilot cone 266a, and an outer wall 266b. The pilot cone 266a is a conical surface having an angle that compliments an angle of the outer cone 224a of the front lens group holder 224. The outer cone 224a of the front lens group holder 224 abuts the pilot cone 266a of the pilot ridge 266, physically aligning the front lens group 222 with the rear lens group 262. The mechanical alignment of the front and rear lens groups 222 and 262 provided by the outer cone 224a and the pilot ridge 266 results in a radial decentration error around the optical axis of less than 0.05 mm, or in embodiments, less than 0.3 mm, as limited by fabrication tolerances of the front and rear lens group holders 224 and 112. The optical axis A may be defined by a lateral position of the imaging sensor 210. The lenses of the front and rear lens groups 222 and 262 are disposed along the optical axis A and are radially centered on the optical axis A. Therefore, radial decentration error, as described herein, refers to an offset or error in lateral position of an optical element, or elements, along the optical axis A. Therefore, if the rear lens group 262 is approximately centered on the optical axis A, the mechanical alignment described above positions the front lens group within 0.05 mm of being centered on the optical axis A. In any examples, the mechanical alignment described radially aligns (i.e., performs optical centration) the front lens group 222 within 0.05 mm of the rear lens group 262.

The outer wall 266b of the pilot ridge 266 may be physically coupled to the outer mount 226 to support and secure a position of the autofocus system 220 relative to the rear lens group holder 112. For examples, the outer mount 226 may be physically coupled to the outer wall 266b by means of a glue, adhesive, epoxy, screw, pin, latch, or other method. As previously described, an actuator 225, having an inner diameter 225a, may be operatively coupled to the front lens group 222, either directly physically coupled to the front lens group 222, or physically coupled to the front lens group holder 224, to control a position of the front lens group 222 along the optical axis A. The actuator 225 may be physically coupled to an outer diameter 224a of the front lens group holder 224, for example, by an adhesive. A radial distance 231 between the outer diameter 224a of the front lens group holder 224 and the inner diameter 225a of the actuator 225 may be 50 microns, 100 microns, between 25 and 100 microns, 50 microns or greater, greater than 100 microns, or greater than 20 microns. The radial distance 231 between the outer diameter 224a of the front lens group holder 224 and the inner diameter 225a of the actuator 225 allows for alignment of the front lens group 222 to the rear lens group 262 without regard to mechanical tolerances or fabrication errors of the actuator 224 itself, or mechanical tolerances of the mounting of the actuator 225, the front lens group holder 224, and the outer mount 226. Without the distance 231, the front lens group holder 224 may interfere with operation of the actuator 225 by physically contacting the actuator 225 and potentially causing damage to and/or malfunction of the front lens group holder 224, front lens group 222, and/or the actuator 225. The distance 231 may be determine by mechanical and fabrication tolerances of the front lens group holder 224, the actuator 225, or elements of the rear lens holder 112 (e.g., the pilot ridge 266, pilot cone 266a, and outer wall 266b).

Translating the position of the front lens group 222 relative to the stationary position of the rear lens group 262 changes the focal distance of the imaging system 110 allowing for imaging of targets or objects of interested at a range of distances. In embodiments, the actuator 225 may be a voice coil motor, a one-dimensional translation stage, a piezoelectric device, a ball-bearing linear motor, a microelectromechanical systems (MEMS) motor, or another actuator capable of translating the position of the front lens group 222. The actuator 225 may provide a translation distance of 0 mm to 0.5 mm, with 0 mm being at a position with the outer cone 224a of the front lens group holder 224 abutting the pilot cone 266a of the pilot ridge 266. In examples, the actuator 225 may provide translation distances of between 0 mm and 0.3 mm, between 0 mm and 1 mm, less than 0.5 mm, less than 1 mm, or another translation distance able to be provided by the actuator 225. Further, the focal distance of the imaging system 110 may be tuned from between 2 inches to a focal distance on infinity. As a person of ordinary skill in the art would recognize, a focal distance of infinity enables imaging of collimated, or parallel, optical rays or image fields that are captured by the imaging system 110. Further, a focal distance at infinity allows for imaging of objects at far distances (e.g., greater than 30 feet) from the imaging system 110 that provide approximately collimated beams to the imaging system 110. In embodiments, the focal distance may be tuned from distances smaller than 2 inches to any distance less than infinity, as capable by the actuator 225 and front and rear lens groups 222 and 262.

The front lens group 222 includes a first lens 230, a second lens, 232, and a third lens 234. The first lens 230 of the front lens group 222 is disposed along the optical axis A configured to receive light from an object of interest or other target for imaging of the target. The first lens 230 is a glass lens with a first spherical surface 230a and a second spherical surface 230b opposite the first spherical surface 230a. The first lens 230 is made out of a Crown type glass with an Abbe value of approximately 52.3±0.5, and has an overall positive optical power. The second lens 232 is disposed along the optical axis A between the second surface 230b of the first lens 230 and the third lens 234. The second lens 232 is an aspheric plastic lens with a first aspheric surface 232a and a second aspheric surface 232b opposite the first aspheric surface 232a. The second lens 232 is made out of a Flint type material with an Abbe value of approximately 21.5±0.5, and has an overall negative optical power. The third lens 234 is disposed along the optical axis A between the second surface 232b of the second lens 232 and the rear lens group 262. The third lens 234 is an aspheric plastic lens with a first aspheric surface 234a and a second aspheric surface 234b opposite the first aspheric surface 234a. The third lens 234 is made out of a Crown type material with an Abbe value of approximately 55.6±0.5, and has an overall positive optical power. The second surface 234b of the third lens 234 of the front lens group 222 provides light from the object or target to the rear leans group 262.

The rear lens group 262 includes a first lens 270, a second lens, 272, a third lens 274, and a fourth lens 276. The first lens 270 of the rear lens group 262 is disposed along the optical axis A configured to receive light from the third lens 234 of the front lens group 222. The first lens 270 is an aspheric plastic lens with a first aspheric surface 270a and a second aspheric surface 270b opposite the first aspheric surface 270a. The first lens 270 is made out of a Flint type material with an Abbe value of approximately 21.5±0.5, and has an overall negative optical power. The second lens 272 is disposed along the optical axis A between the second surface 270b of the first lens 270 and the third lens 274. The second lens 272 is an aspheric plastic lens with a first aspheric surface 272a and a second aspheric surface 272b opposite the first aspheric surface 272a. The second lens 272 is made out of a Crown type material with an Abbe value of approximately 55.6±0.5, and has an overall negative optical power. The third lens 274 is disposed along the optical axis A between the second surface 272b of the second lens 272 and the fourth lens 276. The third lens 274 is an aspheric plastic lens with a first aspheric surface 274a and a second aspheric surface 274b opposite the first aspheric surface 274a. The third lens 274 is made out of a Flint type material with an Abbe value of approximately 21.5±0.5, and has an overall positive optical power. The fourth lens 276 is disposed along the optical axis A between the second surface 274b of the third lens 274 and image sensor 210. The fourth lens 276 is an aspheric plastic lens with a first aspheric surface 276a and a second aspheric surface 276b opposite the first aspheric surface 276a. The fourth lens 276 is made out of a Flint type material with an Abbe value of approximately 21.5±0.5, and has an overall positive optical power. The second surface 276b of the fourth lens 276 provides the light from the target to the image sensor 210.

The above description of the front and rear lens groups 222 and 262 are for illustrative purposes of one embodiment. While the front lens group 222 and the read lens group 262 are described above as having three and four lenses, respectively, each of the front and rear lens groups 222 and 262 may independently have 1, 2, 3, 4, 5, or more lenses for imaging of the object of interest or target. Further, each lens of the front and rear lens groups 222 and 262 may have different Abbe numbers, optical powers, and be made from different materials than the described embodiment. The lenses of the front and rear lens groups 222 and 262 may have various optical characteristics depending on a desired field of view, range of focal distances, and or F numbers of the imaging system 110. For example, each lens may be configured to independently, or in conjunction, magnify, focus, correct for lens distortion, balance field of curvature of the light, correct spherical aberrations, coma, pupil aberrations, chromatic aberrations, and/or any Seidal aberrations.

The imaging system 110 has a back flange focal distance 280 is less than 0.3 mm, and in embodiments of 0.21±0.03 mm. The back flange focal distance is typically considered as the distance between the last optical element, or mechanical element, of an imaging system to the imaging plane at the sensor 210. The back flange focal distance may also be referred to as the back focal distance. In the illustration of the imaging system 110, the back flange focal distance 280 is taken as the distance between a bottom surface 264a of the rear lens barrel flange 264 to the imaging plane at the image sensor 210. Imaging systems that employ small area sensors typically require active alignment of the sensor to achieve high levels of image resolution for processing of images. Active alignment of the image sensor 102 requires that the back flange focal distance 280 be greater than tens of microns to ensure that the image sensor 102 does not physically contact the imaging system 110, potentially damaging the image sensor 102 or elements of the imaging system 110. Typical compact imaging systems employ back flange focal distances of greater than a few millimeters, and usually on the order of tens of millimeters to mitigate optical distortion due to dust, dirt, or minor incongruities of the lenses. The imaging system 110 employs back flange focal distances of less than 1 mm to provide a more compact imaging system while maintaining high resolution and high performance imaging of targets with minimal optical distortion.

The imaging system 110 is able to have a smaller back flange focal distance 280 than other compact systems due to the physical alignment provided by the outer cone 224a and pilot ridge 266. In additional to the centration of the front and rear lens groups 222 and 262, the physical alignment of the imaging system 1110 also allows for the component mounting portion 103 to have a thickness of less than 1 mm. For example, the component mounting portion 103 may be a bead of glue or another adhesive that is approximately 0.5±0.2 mm. Reducing the thickness of the component mounting portion 103 reduces any defocusing of the image plane of the front and rear lens groups 222 and 262 with the image sensor 210. Defocusing effects of thicker component mounting portions 103 include thickness fluctuations due to temperature changes, pressure changes, humidity changes, or material degradation of the component mounting portion. The thin component mounting portion 103 with back flange focal distances 280 of less than 0.5 mm allows for more compact imaging systems having the optical benefits of a large range of focal lengths and reduced defocusing over time as compared to other imaging systems.

All of the features described above contribute to the compact form factor of the imaging system 110. For example, the imaging system may have a length (i.e., distance from the aperture 228 to the circuit board 102) of less than 12 mm, a height (as described above in reference to FIG. 9) of less than 8 mm, and a width of less than 10 mm. So configured, and as illustrated in FIG. 9, the imaging system 110 described herein may occupy an entire available height between the opposing large flat mounting surfaces of the chassis 150 as compared with being constrained by the body 151 of the chassis 150. Further, instead of the chassis 150 being mounted directly to the circuit board 102, the imaging system 110 is mounted directly to the circuit board 102 while the chassis 150 is coupled with the imaging system 110, and indirectly coupled to the chassis 150. Advantageously, such an arrangement isolates heat of the aiming system 170 and the illumination system 180 disposed within the chassis 150 from the image sensor 210 mounted on the circuit board 102, while also providing for additional optical path length for the imaging system 110.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions.

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. An optical assembly for an autofocus imaging system, the optical assembly comprising:
a front aperture disposed along an optical axis configured to receive light from an object of interest therethrough along the optical axis;
a front lens group disposed along the optical axis configured to receive light from the object of interest, wherein the position of the front lens group is adjustable along the optical axis and the position of the front lens group may be adjusted to change a focal distance of the optical assembly;
an actuator physically coupled to the front lens group configured to adjust the position of the front lens group by translating the front lens group along the optical axis;
a rear lens group disposed along the optical axis configured to receive the light from the front lens group and further configured to provide the light to an imaging sensor;
the imaging sensor being disposed along the optical axis at a back focal distance of the rear lens group, and configured to detect the light from the rear lens group and to generate an electrical signal indicative of the light.

2. The optical assembly of claim 1, wherein the actuator comprises one of a voice coil motor, a one-dimension translation stage, a piezoelectric device, a ball-bearing linear motor, or a microelectromechanical systems (MEMS) motor.

3. The optical assembly of claim 1, wherein the front lens group has a travel distance of less than 0.5 mm.

4. The optical assembly of claim 1, wherein the imaging sensor comprises a charge coupled device.

5. The optical assembly of claim 1, wherein the focal distance of the optical assembly may be tuned from between 2 inches and infinity.

6. The optical assembly of claim 1, wherein the back focal distance is less than 3 mm.

7. The optical assembly of claim 1, wherein the front lens group comprises a first glass lens, a second plastic aspheric lens, and a third plastic aspheric lens, the first glass lens disposed along the optical axis between the front aperture and the second plastic aspheric lens, the third aspheric plastic lens disposed between the second aspheric plastic lens and the rear lens group.

8. The optical assembly of claim 7, wherein the first glass lens has a first spherical surface along the optical axis and a second spherical surface opposite the first spherical surface disposed along the optical axis, and wherein the first glass lens is formed of a Crown type glass having a positive optical power, the second plastic substantially aspheric lens of the front lens group has a first aspheric surface along the optical axis and a second aspheric surface along the optical axis, and wherein the second plastic aspheric lens is formed of a Flint type material having a negative optical power, and the third plastic aspheric lens has a first aspheric surface along the optical axis and a second aspheric surface disposed along the optical axis, and the third plastic aspheric lens is formed of a Crown type material having a positive optical power.

9. The optical assembly of claim 1, wherein the rear lens group comprises a first plastic aspheric lens, a second plastic aspheric lens, a third plastic aspheric lens, and a fourth plastic aspheric lens, the first plastic aspheric lens disposed along the optical axis between the third plastic aspheric lens of the front lens group and the second plastic aspheric lens, the third aspheric plastic lens disposed between the second aspheric plastic lens and the fourth plastic aspheric lens, and the fourth plastic aspheric lens disposed between the third plastic aspheric lens and the imaging sensor.

10. The optical assembly of claim 9, wherein the first plastic aspheric lens of the rear lens group has a first aspheric surface along the optical axis and a second aspheric surface opposite the first aspheric surface disposed along the optical axis and wherein the first plastic aspheric lens is formed of a Flint type material having a negative optical power, the second plastic substantially aspheric lens of the second lens group has a first aspheric surface along the optical axis and a second aspheric surface along the optical axis, and wherein the second plastic aspheric lens is formed of a Crown type material having a negative optical power, the third plastic aspheric lens has a first aspheric surface along the optical axis and a second aspheric surface disposed along the optical axis, and wherein the third plastic aspheric lens is formed of a Flint type material having a positive optical power, and the fourth aspheric plastic lens has a first aspheric surface along the optical axis and a second aspheric surface along the optical axis, and wherein the fourth aspheric lens is formed of a Flint type material having appositive optical power.

11. The optical assembly of claim 1, further comprising:
a front lens holder physically coupled to the front lens group to maintain a position of lenses of the front lens group; and
a rear lens holder physically coupled to the rear lens group to maintain a position of lenses of the rear lens group.

12. The optical assembly of claim 11, wherein the actuator is physically coupled to the front lens holder, the actuator configured to adjust the position of the front lens by translating the front lens holder along the optical axis.

13. The optical assembly of claim 11, wherein the front lens holder has an outer cone and the rear lens holder has a pilot cone, wherein the outer cone is configured to abut the pilot cone to align the front lens group to the rear lens group along the optical axis.

14. The optical assembly of claim 13, wherein the outer cone and pilot cone physically align the front lens group to the rear lens group within a radial decentration error, around the optical axis, of less than 0.030 mm.

15. The optical assembly of claim 11, wherein the imaging sensor is disposed on a circuit board, and further comprising a component mounting portion that physically couples the rear lens group holder to the circuit board.

16. The optical assembly of claim 15, wherein the component mounting portion is less than 1 mm thick.

17. The optical assembly of claim 1, wherein the front lens group comprises two aspheric plastic lens.

18. The optical assembly of claim 1, wherein the distance between an outer diameter of the front lens group and an inner diameter of the actuator is 50 microns or greater.

19. The optical assembly of claim 1, wherein the distance from the front aperture to the imaging sensor is less than 12 mm.

20. The optical assembly of claim 1, wherein the object of interest is one of a 1D barcode, 2D barcode, QR code, UPC code, or indicia indicative of the object of interest.
